(19) United States
(12) Patent Application Publication
(10) Pub. No.: US 2020/0265301 A1
(43) Pub. Date: Aug. 20, 2020

(54) INCREMENTAL TRAINING OF MACHINE LEARNING TOOLS

(71) Applicant: Microsoft Technology Licensing, LLC, Redmond, WA (US)

(72) Inventors: Douglas C. Burger, Bellevue, WA (US); Eric S. Chung, Woodinville, WA (US); Bita Darvish Rouhani, Bellevue, WA (US)

(73) Assignee: Microsoft Technology Licensing, LLC, Redmond, WA (US)

(21) Appl. No.: 16/277,735

(22) Filed: Feb. 15, 2019

(51) Int. Cl. G06N 3/08; G06N 3/04; G06K 9/62; G06N 5/04

(52) U.S. Cl. CPC G06N 3/08; G06N 5/04; G06K 9/6253; G06N 3/04

(57) ABSTRACT

Technology related to incremental training of machine learning tools is disclosed. In one example of the disclosed technology, a method can include receiving operational parameters of a machine learning tool based on a primary set of training data. The machine learning tool can be a deep neural network. Input data can be applied to the machine learning tool to generate an output of the machine learning tool. A measure of prediction quality can be generated for the output of the machine learning tool. In response to determining the measure of prediction quality is below a threshold, incremental training of the operational parameters can be initiated using the input data as training data for the machine learning tool. Operational parameters of the machine learning tool can be updated based on the incremental training. The updated operational parameters can be stored.

### BACKGROUND

Machine learning (ML) and artificial intelligence (AI) techniques can be useful for solving a number of complex computational problems such as recognizing images and speech, analyzing and classifying information, and performing various classification tasks. Machine learning is a field of computer science that uses statistical techniques to give computer systems the ability to extract higher-level features from a set of training data. Specifically, the features can be extracted by training a machine learning tool or model such as an artificial neural network (NN) or a deep neural network (DNN). After the model is trained, new data can be applied to the model and the new data can be classified (e.g., higher-level features can be extracted) using the trained model. An accuracy of the model can be a function of the types of training data applied during training. Training and using the models can be computationally expensive and so there can be trade-offs between increasing the accuracy of the model, decreasing the time and computing resources allocated for training the model, and/or reducing energy consumption during training. Accordingly, there is ample opportunity for improvements in computer hardware and software to implement machine learning tools, such as neural networks.

### SUMMARY

Technology related to incremental training of machine learning tools is disclosed. In one example of the disclosed technology, a method can include receiving operational parameters of a machine learning tool based on a primary set of training data. The machine learning tool can be a deep neural network. Input data can be applied to the machine learning tool to generate an output of the machine learning tool. A measure of prediction quality can be generated for the output of the machine learning tool. In response to determining the measure of prediction quality is below a threshold, incremental training of the operational parameters can be initiated using the input data as training data for the machine learning tool. Operational parameters of the machine learning tool can be updated based on the incremental training. The updated operational parameters can be stored.

### BRIEF DESCRIPTION OF THE DRAWINGS

FIG. 1 is a system diagram of an example of a computing system including a server computer and a client device for performing incremental training of a machine learning tool, such as a deep neural network.

FIG. 2 illustrates an example of a deep neural network, as can be modeled using certain example methods and apparatus disclosed herein.

FIG. 3 is a flow diagram depicting a method of training a neural network, as can be implemented in certain examples of the disclosed technology.

FIG. 4 is a system diagram of an example server computing system for performing incremental training of a machine learning tool, as can be implemented in certain examples of the disclosed technology.

FIG. 5 is a system diagram of an example client computing device for performing incremental training of a machine learning tool, as can be implemented in certain examples of the disclosed technology.

FIG. 6 illustrates a method of updating operational parameters of a neural network model using a client computing device, as can be implemented in certain examples of the disclosed technology.

FIG. 7 illustrates a method of updating operational parameters of a neural network model using a client computing device, as can be implemented in certain examples of the disclosed technology.

FIG. 8 illustrates a method of performing incremental training of a machine learning tool using a server computer, as can be implemented in certain examples of the disclosed technology.

FIG. 9 is a block diagram illustrating a suitable computing environment for implementing some examples of the disclosed technology.

### DETAILED DESCRIPTION

### General Considerations

This disclosure is set forth in the context of representative examples that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed examples, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed examples can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “verify,” “execute,” and “initiate” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques, as well as any data created and used during implementation of the disclosed examples, can be stored on one or more computer-readable media (e.g., computer-readable storage media). The computer-executable instructions can be part of, for example, a dedicated software application or a software application that is accessed or downloaded via a web browser or other software application (such as a remote computing application). Such software can be executed, for example, on a single local computer or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

### Overview

Machine learning (ML) and artificial intelligence (AI) techniques can be useful for solving a number of complex computational problems such as recognizing images and speech, analyzing and classifying information, and performing various classification tasks. Machine learning is a field of computer science that uses statistical techniques to give computer systems the ability to categorize and/or extract higher-level features from a set of training data. Specifically, the features can be extracted by training a machine learning tool such as an artificial neural network (NN) or a deep neural network (DNN). A machine learning tool can include hardware, software, or a combination thereof, that performs a task (e.g., feature extraction and classification) using inferences that are derived by training the machine learning tool. The inferences can be captured in operating parameters of the machine learning tool so that changes to the operating parameters can result in the machine learning tool performing different tasks or performing a given task differently. The machine learning tool processing may take place on individual edge devices such as personal computers or cell phones, on server computers in large datacenters (e.g., the cloud), and/or in combinations thereof.

As one example, a DNN model can be trained on a server computer within a cloud or other computing system. The training can be performed using an initial set of labeled training data. Labelling can be performed by a data scientist (supervised) or by an automated tool (unsupervised). The initial set of labeled training data has a finite number of samples representing known, typical, and/or anticipated input data. An accuracy of the DNN model trained on the initial set of training data can be good (e.g., over 99% accurate) when classifying input data that is similar to the initial training data, but the DNN model may perform less accurately when input data varying from the typical or anticipated norm is encountered.

For example, the DNN model can be trained on the server computer using the initial training data and then distributed and deployed within one or more applications on a number (e.g. thousands, millions, or billions) of client devices (also referred to as edge devices). Each of the different edge devices can collect input data that may differ in some ways from the initial set of labeled training data. The accuracy of the DNN model can potentially be improved if some or all of the input data collected by the edge devices is used to incrementally train the DNN model. One solution could be to store all input data collected on each edge device, send the input data to the server computer, have a person or automated tool label the input data, and use this labeled input data for retraining the model. However, this approach is probably not effective because it may use a high amount of storage resources and the cost of labeling and model retraining may be too high in terms of time, computing resources, and/or energy consumption.

As described herein, the accuracy of the DNN model can potentially be improved by selectively using input data collected by the edge devices to incrementally train the DNN model. As one example, input data can be collected (e.g., in a streaming setting) by an input sensor of an edge device. The input data can be applied as an input to the initially-trained DNN model to generate a classification of the input data as an output of the DNN model. The prediction quality of the classification can be measured to determine whether the input data was classified with a high degree of accuracy and/or confidence. The prediction quality can be measured in various ways, such as by measuring a perplexity of the input sample. If the prediction quality indicates a low confidence in and/or a low accuracy of the prediction, then the input data can be used as training data to incrementally train the DNN model. In this manner, an unsupervised approach can be used to measure the prediction quality (such as by measuring a perplexity of the DNN model output) of input samples collected on the edge and selectively decide to upload informative samples to the server computer for incrementally training the DNN model.

This approach can potentially: improve an overall accuracy of the deployed DNN model; reduce a communication workload between edge devices and the server computer; reduce a cost of data labeling by reducing or minimizing redundancy and/or repetition in the training data; reduce a DNN retraining cost by only processing more informative samples; and recycle unlabeled data collected on the edge devices by looking for informative samples. The approach can operate in a fully or partially unsupervised manner with or without human-generated labels for the training data.

As used herein, the term “tensor” refers to a multi-dimensional array that can be used to represent properties of a NN and includes one-dimensional vectors as well as two-, three-, four-, or larger dimension matrices. As used in this disclosure, tensors do not require any other mathematical properties unless specifically stated.

As used herein, the term “normal-precision floating-point” refers to a floating-point number format having a mantissa, exponent, and optionally a sign and which is natively supported by a native or virtual CPU. Examples of normal-precision floating-point formats include, but are not limited to, IEEE 754 standard formats such as 16-bit, 32-bit, 64-bit, or to other processors supported by a processor, such as Intel AVX, AVX2, IA32, and x86-64 80-bit floating-point formats.

A given number can be represented using different precision (e.g., mixed precision) formats. For example, a number can be represented in a higher precision format (e.g., float32) and a lower precision format (e.g., float16). Lowering the precision of a number can include reducing the number of bits used to represent the mantissa or exponent of the number. Additionally, lowering the precision of a number can include reducing the range of values that can be used to represent an exponent of the number, such as when multiple numbers share a common exponent. Similarly, increasing the precision of a number can include increasing the number of bits used to represent the mantissa or exponent of the number. Additionally, increasing the precision of a number can include increasing the range of values that can be used to represent an exponent of the number, such as when a number is separated from a group of numbers that shared a common exponent. As used herein, converting a number from a higher precision format to a lower precision format may be referred to as down-casting or quantizing the number. Converting a number from a lower precision format to a higher precision format may be referred to as up-casting or de-quantizing the number.

As used herein, the term “quantized-precision floating-point” refers to a floating-point number format where two or more values of a tensor have been modified to have a lower precision than when the values are represented in normal-precision floating-point. In particular, many examples of quantized-precision floating-point representations include block floating-point formats, where two or more values of the tensor are represented with reference to a common exponent. The quantized-precision floating-point number can be generated by selecting a common exponent for two, more, or all elements of a tensor and shifting mantissas of individual elements to match the shared, common exponent. In some examples, groups of elements within a tensor can share a common exponent on, for example, a per-row, per-column, per-tile, or other basis.

### Example Architectures

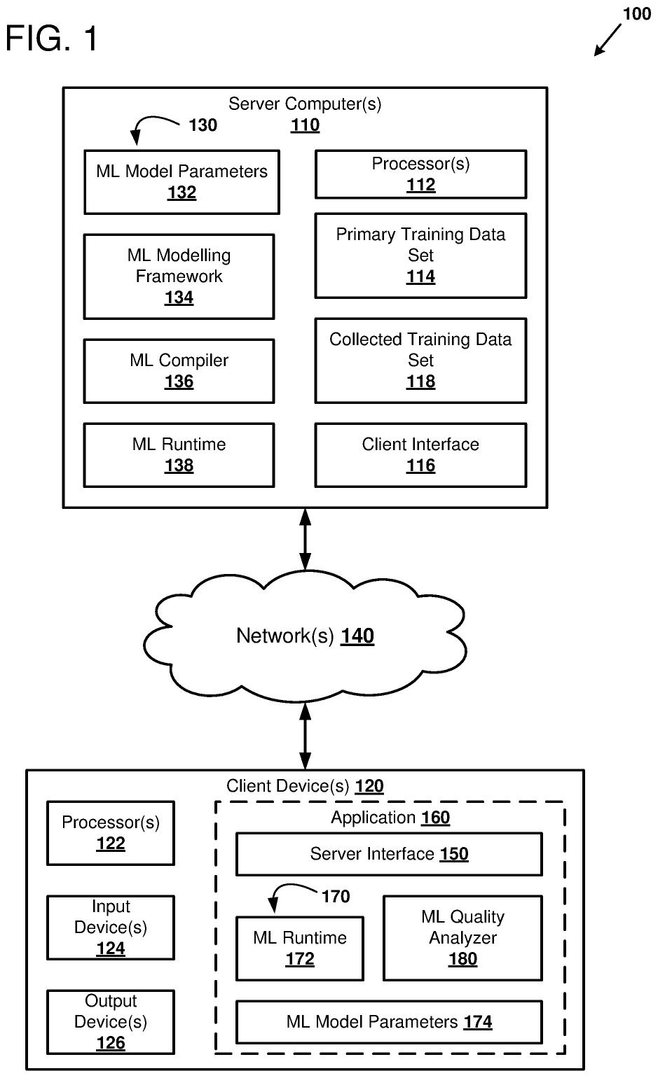

FIG. 1 is a system diagram of an example computing system 100 including one or more server computer(s) 110 and one or more client device(s) 120 for performing incremental training of a machine learning tool, such as a deep neural network. For example, the server computer(s) 110 can be located in a datacenter as part of a cloud service that is offered for use by customers of the cloud service provider. A given server computer 110 can include computer hardware, such as one or more processors 112, and computer software, such as the machine learning tool flow 130. The machine learning tool flow 130 can be used for specifying, training, and/or executing a machine learning tool, such as a DNN model.

The machine learning tool flow 130 can include various hardware and/or software components for specifying, training, and/or executing a machine learning tool. As illustrated, the machine learning tool flow 130 can include model parameters 132, a modeling framework 134, a compiler 136, and a runtime environment 138. The model parameters 132 can specify an architecture (e.g., a number of layers, a number of neurons within a layer, connections or edges between and within layers, activation functions of the neurons, and so forth) and operating parameters (e.g., weights assigned to an edge, biases of a neuron, and so forth) of the machine learning tool. Some or all of the model parameters 132 can be determined by training the machine learning tool using representative input data, such as primary training data set 114. The modeling framework 134 can provide a programming model and/or programming primitives for specifying the machine learning tool in conjunction with the model parameters 132. The compiler 136 can be used to transform a specification (e.g., model parameters 132) for the machine learning tool into a format that can be executed by the runtime environment 138. The runtime environment 138 can provide an executable environment or an interpreter that can be used to train the machine learning tool during a training mode and that can be used to evaluate the machine learning tool in training and inference or classification modes. During the inference mode, input data can be applied to the machine learning tool inputs and the input data can be classified in accordance with the training of the machine learning tool. The machine learning tool can initially be trained using input data from the primary training data set 114. The primary training data set 114 can include input data that is representative of typical or expected input data. By training the machine learning tool using the primary training data set 114, an initial set of operating parameters can be determined for the machine learning tool so that the machine learning tool can categorize input data according to its training. After initial training using the primary training data set 114, the machine learning tool can be distributed to the client device 120.

For example, the computer server 110 can be connected to and in communication with the client device 120 using an interconnection network 140. The computer server 110 can include a client interface 116 which can be used to communicate with the client device 120 using an application programming interface (API) or other communication protocol that is encapsulated in packets transiting the network 140. The client device 120 can include a server interface 150 which can be used to communicate with the server computer 110 using the API or other communication protocol. The network 140 can include a local area network (LAN), a Wide Area Network (WAN), the Internet, an intranet, a wired network, a wireless network, a cellular network, combinations thereof, or any network suitable for providing a channel for communication between the server computer 110 and the client device 120. It should be appreciated by one of ordinary skill in the art having the benefit of the present disclosure, that the network topology illustrated in FIG. 1 has been simplified and that multiple networks and networking devices can be utilized to interconnect the various computing systems disclosed herein.

The client device 120 can include various types of clients, such as desktop computers, laptops, tablets, smartphones, sensors, set-top boxes, game consoles, and smart televisions running web browsers and/or other client applications, such as the optional application 160. The client device 120 can include computer hardware (such as one or more processors 122, one or more input devices 124, and one or more output devices 126) and computer software (such as the application 160, an operating system (not shown), and so forth) for executing a machine learning tool 170. The input devices 124 can be used for collecting information about the environment and/or for communicating with a user of the client device. For example, the input devices 124 can include a microphone, a camera, a video camera, a keyboard, a computer mouse, and so forth. The output devices 126 can be used for communicating with the user of the client device. For example, the output devices 126 can include a speaker, a computer monitor, a printer, and so forth.

The machine learning tool 170 can include various components. As one example, the machine learning tool 170 can include a runtime environment 172 and model parameters 174. The machine learning tool 170 can receive raw and/or processed input data from the input device 124, and the machine learning tool 170 can be used to classify and/or extract features from the input data. The input data to the machine learning tool 170 can be spoken speech, images, time-series data such as temperatures from a temperature sensor, and so forth. The machine learning tool 170 can operate according to the model parameters 174. Initially, the model parameters 174 can be the same as the model parameters 132 that were trained on the server computer 110. These model parameters 174 may be sufficiently accurate for the primary training data set 114, but may have less accuracy when new input data is being processed by the machine learning tool 170.

A quality analyzer 180, which can be part of the machine learning tool 170 and/or the application 160, can be used to analyze a quality of the results from the machine learning tool 170. High-quality results can indicate that the machine learning tool 170 accurately predicted the classification of the input data, such as when the input data is similar to the training data. Low-quality results can indicate that the machine learning tool 170 did not accurately predict the classification of the input data such as when the input data differs in some way from the training data. The input data leading to the low-quality results can be helpful when used to supplement the initial training data during incremental training of the machine learning tool 170. By using the input data causing the low-quality results for incremental training, the machine learning tool 170 can be adjusted (e.g., the model parameters 132 and 174 can be updated) to better predict input data that is similar to the incremental input data.

The quality analyzer 180 can use various techniques to determine the quality of the results from the machine learning tool 170 for a given set of input data. As one example, a misclassification by the machine learning tool 170 can indicate that the quality of the results is poor. Specifically, the application 160 may present the classification from the machine learning tool 170 to a user of the client device 120 via a user interface presented on an output device 126. The user may indicate that the classification is incorrect by responding using the input device 124. The quality analyzer 180 can mark the input data as data that was misclassified and the misclassified input data can be uploaded (with or without a correct label) to the server computer 110 (using the server interface 150) to be added to the collected training data set 118. The input data of the collected training data set 118 can be used to incrementally train the machine learning tool so that the model parameters 132 can be adjusted based on the new training data. The adjusted model parameters 132 can then be redistributed to the client device 120 so that the machine learning tool 170 can be adapted based on the original misclassified input data.

As a specific example, the machine learning tool 170 can be an image classifier. A user of the client device 120 can take a picture of a cat, but the machine learning tool 170 may misclassify the picture as a dog. The user can recognize the misclassification and correctly label the image as a cat. The misclassification can be detected, and the image, along with the correct label (e.g., cat) can be uploaded to the server computer 110 to be added to the collected training data set 118. The server computer 110 can perform incremental training using the collected input data so that the machine learning tool can be improved by updating the model parameters 132 and redistributing the model parameters 132 to the client device 120.

The quality analyzer 180 can also determine a quality of the results from the machine learning tool 170 in an unsupervised manner using mathematical and/or statistical properties of outputs of the machine learning tool 170. For example, the machine learning tool 170 can include a deep neural network and a perplexity of the outputs of the last layer can be used to determine the quality of the results. Perplexity can be calculated in various ways, but perplexity is a measure of a variability of a prediction model and/or a measure of prediction error. In other words, a perplexity measure indicates how “surprising” an output of a neural network is relative to other outputs for a particular training batch or training epoch. As a specific example, the last layer of the DNN can be a five-neuron soft-max layer, where the neuron outputs have values between zero and one, and a sum of the neuron outputs equal one. Thus, the outputs of the soft-max layer can represent a probability distribution for the input belonging to a class represented by a respective neuron. If the DNN perfectly predicts that input data belongs to a given class, then the output of the neuron belonging to the class will be one and the output of the other neurons will be zero (e.g., the output from the final layer will be a one-hot vector, such as (0, 0, 1, 0, 0)). However, if the DNN is classifying data that is significantly different from the training data, the DNN may output a result that indicates the data cannot be classified with the current training with a high degree of certainty (e.g., the output from the final layer can look something like (0.20, 0.18, 0.24, 0.26, 0.12)). One measure of perplexity can quantify how close the output vector is to a one-hot vector, such as by measuring a cross-entropy between the output vector and a one-hot vector. Another measure of perplexity can quantify characteristics of the distribution of the final layer without comparing the outputs to a one-hot vector, such as by measuring an entropy of the output vector.

The perplexity measure indicates how difficult an associated sample is to classify with the neural network. One example of a suitable perplexity measure is described by the following equation, where zᵢ is the input sample, p(zᵢ) is a one-hot vector generated based on a data label, q(zᵢ) is a prediction of the DNN model, and C is the total number of classes in a given application:

px(zᵢ)=2^{-Σ}^{ⱼ₌₂}^{^{C}}^{p}^{ⱼ}^{(z}^{ᵢ}^{)log(q}^{ⱼ}^{(m}^{ᵢ}^{)j}

In some examples, a log of the perplexity value can be used for simplification. At a given training epoch, a low log-perplexity value implies that the sample is a typical sample and that the neural network model is not “surprised” with the particular sample. In other words, the sample has a relatively low loss value. A high perplexity value indicates that the input sample is hard to classify with the current DNN model. As will be readily understood to one of ordinary skill in the relevant art having the benefit of the present disclosure, other suitable measures of perplexity besides the one expressed in the equation above may be used.

Additionally, the quality analyzer 180 can determine the quality of the results from the machine learning tool 170 using mathematical and/or statistical properties of intermediate outputs and/or final outputs of the machine learning tool 170. For example, the machine learning tool 170 can be a DNN having multiple layers of neurons. The quality of the results can be measured using statistical properties of outputs of the final layer and/or of a hidden layer, such as the layer that precedes the final layer. In other words, the quality of the results can be measured using mathematical properties of outputs of a mixture of layers of the DNN. As a specific example, the final layer can be a soft-max layer (the neurons of last layer use the soft-max activation function) and the preceding layer can be a layer having multi-dimensional outputs where the neurons use a sigmoid or rectified linear unit (ReLU) activation function. The outputs of the preceding layer of DNN may map to subclasses within the classes that are identified in the final layer of the DNN. A cluster analysis or a principal components analysis can be performed to determine how close the output of the preceding layer is to one of the subclasses. A high quality (low perplexity) result will be close to a cluster representing the subclasses, contrarily a low quality (high perplexity) result will be farther from the clusters representing the different subclasses.

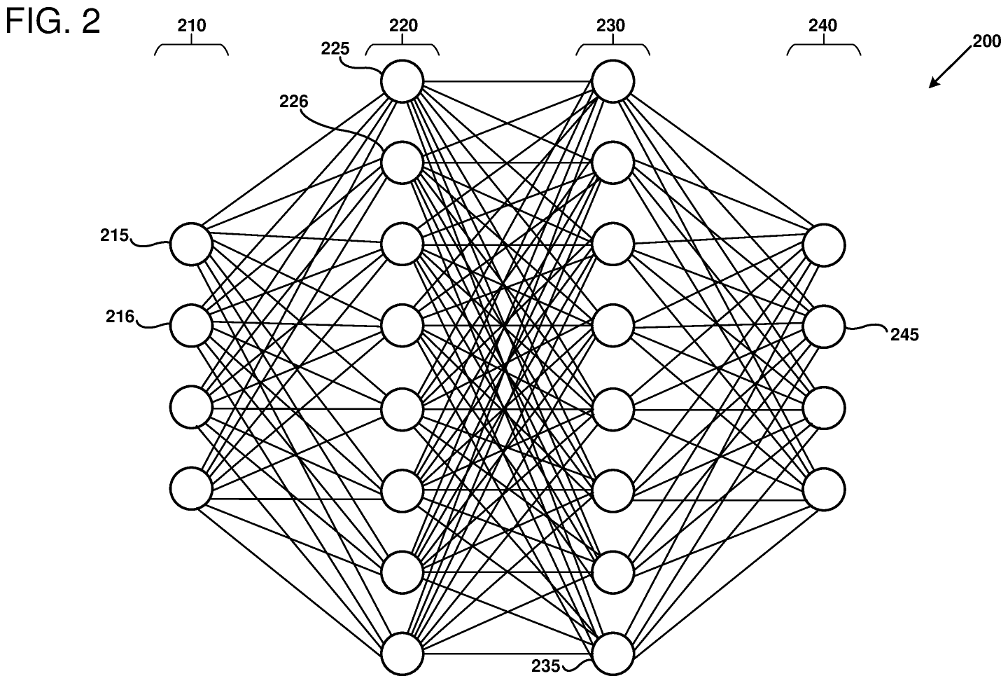

FIG. 2 illustrates an implementation of a machine learning tool. Specifically, FIG. 2 illustrates a simplified topology of a deep neural network (DNN) 200 that can be used to perform enhanced image processing using disclosed training implementations. The DNN 200 can be implemented using disclosed systems, such as the computer system 100 described above. It should be noted that machine learning tools can include the neural network implementations disclosed herein (e.g., DNNs) and also other types of artificial neural networks, such as convolutional neural networks (CNNs), including implementations having Long Short Term Memory (LSTMs) or gated recurrent units (GRUs), or other suitable artificial neural networks.

The DNN 200 can operate in at least two different modes. Initially, the DNN 200 can be trained in a training mode and then used as a classifier in an inference mode. During the training mode, one or more sets of training data can be applied to inputs of the DNN 200 and various operating parameters of the DNN 200 can be adjusted so that at the completion of training, the DNN 200 can be used as a classifier. Training includes performing forward propagation of the training input data, calculating a loss (e.g., determining a difference between an output of the DNN and the expected outputs of the DNN), and performing backward propagation through the DNN to adjust operating parameters (e.g., weights and biases) of the DNN 200. When an architecture of the DNN 200 is appropriate for classifying the training data, the operating parameters of the DNN 200 will converge and the initial training can complete. After initial training, the DNN 200 can be distributed to edge devices and used in the inference mode on the edge devices and/or within a datacenter. Specifically, training or non-training data can be applied to the inputs of the DNN 200 and forward propagated through the DNN 200 so that the input data can be classified by the DNN 200. When input data with high perplexity is discovered (such as at an edge device), the discovered input data can be used to supplement the initial training data. Specifically, the discovered input data can be used to incrementally train the DNA and 200.

As shown in FIG. 2, a first set 210 of neural nodes (including nodes 215 and 216) form an input layer. Each node of the set 210 is connected to each node in a first hidden layer formed from a second set 220 of neural nodes (including nodes 225 and 226). A second hidden layer is formed from a third set 230 of nodes, including node 235. An output layer is formed from a fourth set 240 of nodes (including node 245). In example 200, the nodes of a given layer are fully interconnected to the nodes of its neighboring layer(s). In other words, a layer can include nodes that have common inputs with the other nodes of the layer and/or provide outputs to common destinations of the other nodes of the layer. In other examples, a layer can include nodes that have a subset of common inputs with the other nodes of the layer and/or provide outputs to a subset of common destinations of the other nodes of the layer.

During forward propagation, each of the neural nodes produces an output by applying a weight to each input generated from the preceding node and collecting the weights to produce an output value. In some examples, each individual node can have an activation function (σ) and/or a bias (b) applied. Generally, an appropriately programmed processor or FPGA can be configured to implement the nodes in the depicted neural network 200. In some example neural networks, an output function f (n) of a hidden combinational node n can produce an output expressed mathematically as:

$$f ( n ) = σ ( {\sum }_{i = 0 to R - 1} {w}_{i} {x}_{i} + b )$$

where wᵢ is a weight that is applied (multiplied) to an input edge xᵢ, b is a bias value for the node n, σ is the activation function of the node n, and E is the number of input edges of the node n. A given DNN can use uniform activation functions or a mixture of activation functions for the nodes of the DNN. As one example, the activation functions of the nodes within a given layer can be the same, and some layers may use different activation functions than different layers. In some examples, the activation function produces a continuous value (represented as a floating-point number) between 0 and 1. In some examples, the activation function produces a binary 1 or 0 value, depending on whether the summation is above or below a threshold. In some examples, such as in the final layer of a classifier, the activation functions within a layer can use the soft-max activation function where a sum of the outputs of the layer are equal to one, and the individual node outputs within the layer are between zero and one. The weights, biases, activation functions, number of neurons, arrangement of the neurons within the layers, and the edge connections determine how the DNN classifies input data, and can be stored as the model parameters of the DNN.

A given neural network can include thousands of individual nodes and so performing all of the calculations for the nodes in normal-precision floating-point can be computationally expensive. An implementation for a more computationally expensive solution can include hardware that is larger and consumes more energy than an implementation for a less computationally expensive solution. By selectively choosing input data with a high perplexity to train the neural network model, the model can achieve a higher accuracy using less energy compared to using random samples or other methods to select the training set. Additionally, hardware accelerators, such as those that perform neural network operations using quantized floating-point or in mixed precision (using both normal-precision floating-point and quantized floating-point) can potentially further reduce the computational complexity and the energy consumption of the neural network.

A mixed precision implementation of the DNN 200 can include nodes that perform operations in both normal precision floating-point and quantized floating-point. As a specific example, an output function f (n) of a hidden combinational node n can produce an output expressed mathematically as:

$$f ( n ) = σ ( {Q}^{- 1} ( {\sum }_{i = 0 to R - 1} Q ( {w}_{i} ) Q ( {x}_{i} ) ) + b )$$

where wᵢ is a weight that is applied (multiplied) to an input edge xᵢ, Q(wᵢ) is the quantized floating-point value of the weight, Q(xᵢ) is the quantized floating-point value of the input sourced from the input edge xᵢ, Q⁻¹( )is the de-quantized representation of the quantized floating-point value of the dot product of the vectors w and x, b is a bias value for the node n, σ is the activation function of the node n, and E is the number of input edges of the node n. The computational complexity can potentially be reduced (as compared with using only normal-precision floating-point values) by performing the dot product using quantized floating-point values, and the accuracy of the output function can potentially be increased by (as compared with using only quantized floating-point values) by the other operations of the output function using normal-precision floating-point values.

Neural networks can be trained and retrained by adjusting constituent values of the output function f(n). For example, by adjusting weights wᵢ or bias values b for a node, the behavior of the neural network is adjusted by corresponding changes in the networks output tensor values. For example, a cost function C(w, b) can be used during back propagation to find suitable weights and biases for the network, where the cost function can be described mathematically as:

$$C ( w , b ) = \frac{1}{2 n} {\sum }_{x} {‖ y ( x ) - a ‖}^{2}$$

where w and b represent all weights and biases, n is the number of training inputs, a is a vector of output values from the network for an input vector of training inputs x. By adjusting the network weights and biases, the cost function C can be driven to a goal value (e.g., to zero (0)) using various search techniques, for examples, stochastic gradient descent. The neural network is said to converge when the cost function C is driven to the goal value. Similar to the output function f(n), the cost function can be implemented using mixed-precision computer arithmetic. For example, the vector operations can be performed using quantized floating-point values and operations, and the non-vector operations can be performed using normal-precision floating-point values.

Examples of suitable applications for such neural network implementations include, but are not limited to: performing image recognition, performing speech recognition, classifying images, translating speech to text and/or to other languages, facial or other biometric recognition, natural language processing, automated language translation, query processing in search engines, automatic content selection, analyzing email and other electronic documents, relationship management, biomedical informatics, identifying candidate biomolecules, providing recommendations, or other classification and artificial intelligence tasks.

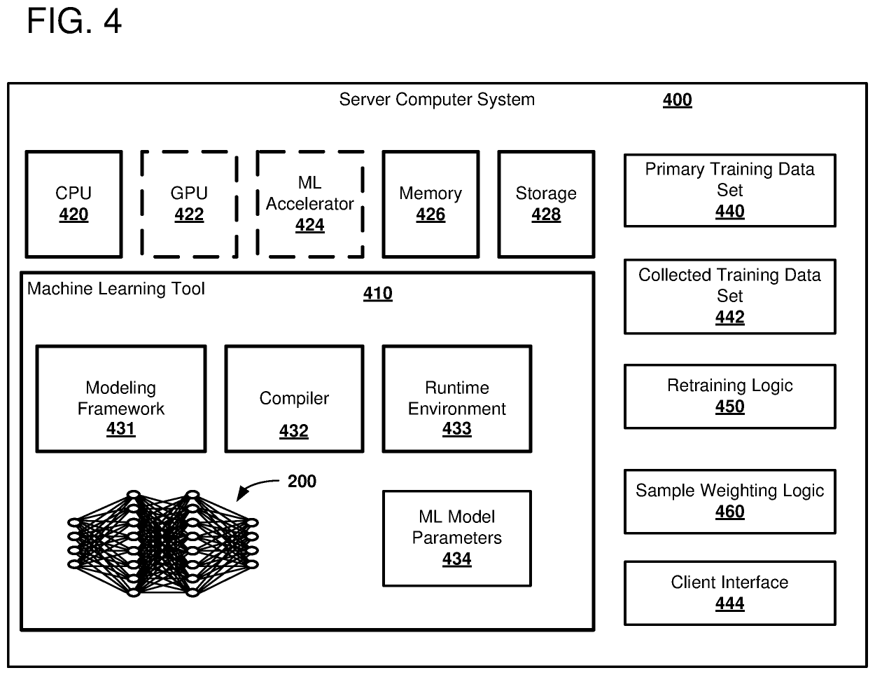

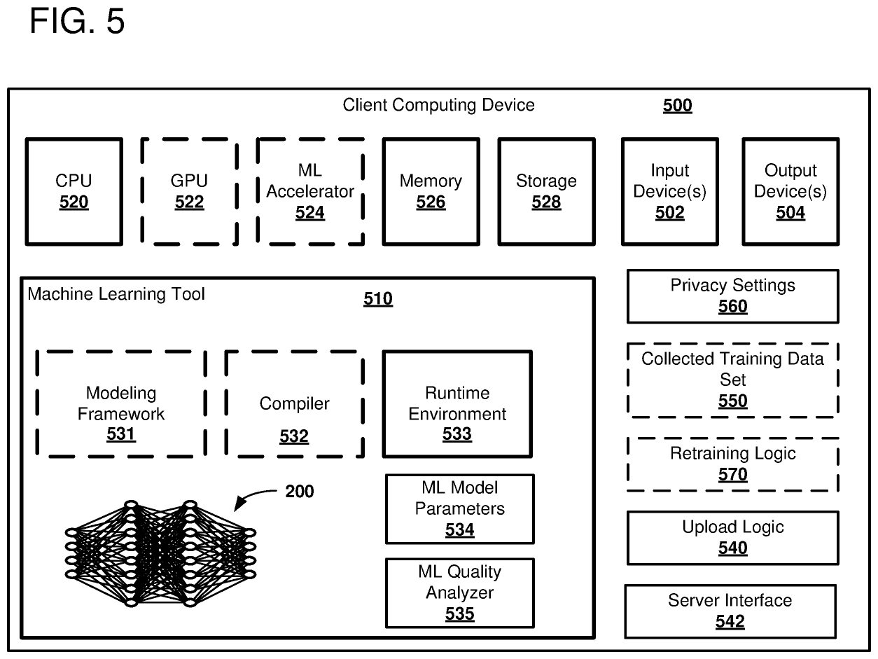

A network accelerator (such as the ML accelerators 424 and 524 in FIGS. 4 and 5, respectively) can be used to accelerate the computations of the DNN 200. As one example, the DNN 200 can be partitioned into different subgraphs that can be individually accelerated. As a specific example, each of the layers 210, 220, 230, and 240 can be a subgraph that is accelerated. The computationally expensive calculations of the layer can be performed using quantized floating-point and the less expensive calculations of the layer can be performed using normal-precision floating-point. Values can be passed from one layer to another layer using normal-precision floating-point. By accelerating a group of computations for all nodes within a layer, some of the computations can be reused and the computations performed by the layer can be reduced compared to accelerating individual nodes.

In some examples, a set of parallel multiply-accumulate (MAC) units in each convolutional layer can be used to speed up the computation. Also, parallel multiplier units can be used in the fully-connected and dense-matrix multiplication stages. A parallel set of classifiers can also be used. Such parallelization methods have the potential to speed up the computation even further at the cost of added control complexity.

As will be readily understood to one of ordinary skill in the art having the benefit of the present disclosure, the application of neural network implementations can be used for different aspects of using neural networks, whether alone or in combination or sub-combination with one another. For example, disclosed implementations can be used to implement neural network training via gradient descent and/or back propagation operations for a neural network. Further, disclosed implementations can be used for evaluation of neural networks.

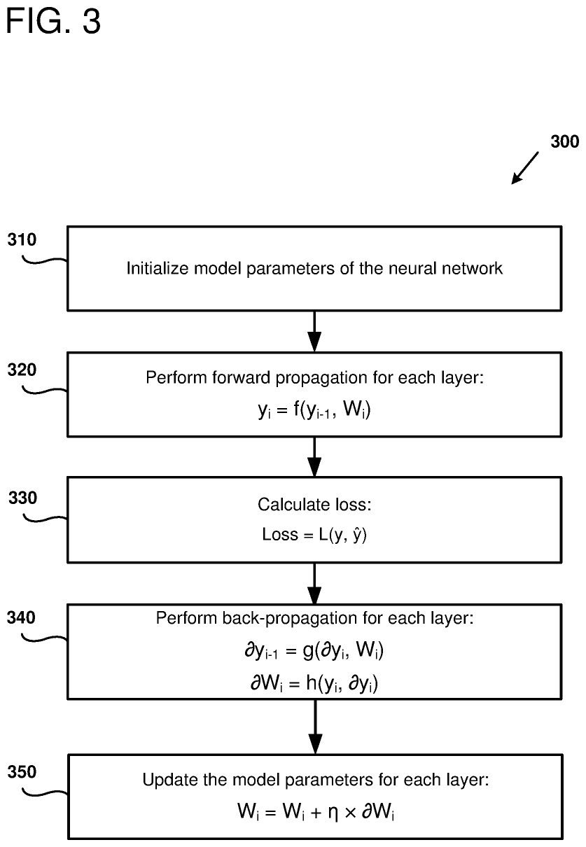

FIG. 3 is a flow diagram depicting a method of training a neural network, as can be implemented in certain examples of the disclosed technology. For example, training the neural network can include iterating through a set of training data, where the method 300 is used for updating the parameters of the neural network during a given iteration of training data. The training can occur in multiple phases, such as an initial training phase with the initial or primary training data, and an incremental training phase after new training data is collected. As one example, the method 300 can be performed by a distributed computing system, such as the computing 100 of FIG. 1.

At process block 310, model parameters, such as weights and biases, of the neural network can be initialized. As one example, the weights and biases can be initialized to random normal-precision floating-point values. As another example, the weights and biases can be initialized to normal-precision floating-point values that were calculated from an earlier training set. The initial parameters can be stored in a memory or storage of the computing system. In one example, the model parameters can be stored as quantized floating-point values which can reduce an amount storage used for storing the initial parameters.

At process block 320, input values of the neural network can be forward propagated through the neural network. Input values of a given layer of the neural network can be an output of another layer of the neural network. The values can be passed between the layers from an output of one layer to an input of the next layer using normal-precision or quantized floating-point. The output function of the layer i can include a term that is described mathematically as:

yᵢ=f(yᵢ₋₁, Wᵢ)

where yᵢ₋₁ is the output from a layer providing the input to layer i, Wᵢ is the weight tensor for the layer i, and f( ) is a forward function of the layer. The output function of the layer can include additional terms, such as an activation function or the addition of a bias. Generally, the inputs, outputs, and parameters of the layers are tensors. Typically, the inputs, outputs, and parameters of the layers will be vectors or matrices. A quantization function can convert normal-precision floating-point values to quantized floating-point values. The quantization function can be selected to account for the type of input data and the types of operations performed by the layer i. For example, when yᵢ and Wᵢ are two-dimensional matrices and the output function includes a term that takes the cross product of yᵢ₋₁ and Wᵢ, the quantization function for yᵢ₋₁ can use a tile including a row or a portion of a row of yᵢ₋₁, and the quantization function for Wᵢ can use a tile including a column or a portion of a column of Wᵢ. The computation can be more efficient when selecting the tiles to follow the flow of the operators, thus making a hardware implementation smaller, faster, and more energy efficient. A de-quantization function converts quantized floating-point values to normal-precision floating-point values.

At process block 330, a loss of the neural network can be calculated. For example, the output y of the neural network can be compared to an expected output ŷ of the neural network. A difference between the output and the expected output can be an input to a cost function that is used to update the parameters of the neural network.

At process block 340, the loss of the neural network can be back-propagated through the neural network. During back propagation, an output error term ∂y and a weight error term ∂W can be calculated. The output error term can be described mathematically as:

∂yᵢ₋₁=g(∂yᵢ, Wᵢ)

where ∂yᵢ₋₁ is the output error term from a layer following layer i, Wᵢ is the weight tensor for the layer i, and g( ) is a backward function of the layer. The backward function g( ) can be the backward function of f( ) for a gradient with respect to yᵢ₋₁ or a portion of the gradient function. The output error term of the layer can be a de-quantized representation of g( ) or the output error term can include additional terms that are performed using normal-precision floating-point (after de-quantization) or using quantized floating-point (before de-quantization).

The weight error term σW can be described mathematically as:

∂Wᵢ=h(yᵢ, ∂yᵢ)

where ∂Wᵢ is the weight error term for the layer i, ∂yᵢ is the output error term for the layer i, yᵢ is the output for the layer i, and h( ) is a backward function of the layer. The backward function h( ) can be the backward function of f( ) for a gradient with respect to Wᵢ₋₁ or a portion of the weight error equation. The weight error term of the layer can be the de-quantized representation of h( ) or the weight error term can include additional terms that are performed using normal-precision floating-point (after de-quantization) or using quantized floating-point (before de-quantization). The weight error term can include additional terms that are performed using normal-precision floating-point.

At process block 350, the model parameters for each layer can be updated. For example, the weights for each layer can be updated by calculating new weights based on the iteration of training. As one example, a weight update function can be described mathematically as:

Wᵢ=Wᵢ+η×∂Wᵢ

where ∂Wᵢ is the weight error term for the layer i, η is the learning rate for the layer i for the neural network, Wᵢ is the weight tensor for the layer i. In one example, the weight update function can be performed using normal-precision floating-point.

FIG. 4 is a system diagram of an example of a server computing system 400 for performing incremental training of a machine learning tool 410, as can be implemented in certain examples of the disclosed technology. As shown in FIG. 4, the server computing system 400 can include a number of hardware resources including general-purpose processors 420 and optional special-purpose processors such as graphics processing units 422 and machine learning accelerator 424. The processors are coupled to memory 426 and storage 428, which can include volatile or non-volatile memory devices. The processors 420 and 422 execute instructions stored in the memory or storage in order to provide a machine learning tool 410. The machine learning tool 410 includes software interfaces that allow the system to be programmed to implement various types machine learning models, such as neural networks. For example, software functions can be provided that allow applications to define neural networks including weights, biases, activation functions, node values, and interconnections between layers of a neural network. Additionally, software functions can be used to define state elements for recurrent neural networks. The machine learning tool 410 can further provide utilities to allow for training and retraining of a neural network implemented with the module. Values representing the neural network module are stored in memory or storage and are operated on by instructions executed by one of the processors. The values stored in memory or storage can be represented using normal-precision floating-point and/or quantized floating-point values.

In some examples, proprietary or open source libraries or frameworks are provided to a programmer to implement neural network creation, training, and evaluation. Examples of such libraries include TensorFlow, Microsoft Cognitive Toolkit (CNTK), Caffe, Theano, and Keras. In some examples, programming tools such as integrated development environments provide support for programmers and users to define, compile, and evaluate NNs.

The machine learning accelerator 424 can be implemented as a custom or application-specific integrated circuit (e.g., including a system-on-chip (SoC) integrated circuit), as a field programmable gate array (FPGA) or other reconfigurable logic, or as a soft processor virtual machine hosted by a physical, general-purpose processor. The machine learning accelerator 424 can include a tensor processing unit, reconfigurable logic devices, and/or one or more neural processing cores. The machine learning accelerator 424 can be configured in hardware, software, or a combination of hardware and software. As one example, the machine learning accelerator 424 can be configured and/or executed using instructions executable on a tensor processing unit. As another example, the machine learning accelerator 424 can be configured by programming reconfigurable logic blocks. As another example, the machine learning accelerator 424 can be configured using hard-wired logic gates.

The machine learning accelerator 424 can be programmed to execute all or a portion (such as a subgraph or an individual node) of a neural network. For example, the machine learning accelerator 424 can be programmed to execute a subgraph including a layer of a NN. The machine learning accelerator 424 can access a local memory used for storing weights, biases, input values, output values, and so forth. The machine learning accelerator 424 can have many inputs, where each input can be weighted by a different weight value. For example, the machine learning accelerator 424 can produce a dot product of an input tensor and the programmed input weights for the machine learning accelerator 424. In some examples, the dot product can be adjusted by a bias value before it is used as an input to an activation function. The output of the machine learning accelerator 424 can be stored in the local memory, where the output value can be accessed and sent to a different NN processor core and/or to the machine learning tool 410 or the memory 426, for example.

The machine learning tool 410 can be used to specify, train, and evaluate a neural network model using a tool flow that includes a hardware-agnostic modelling framework 431 (also referred to as a native framework or a machine learning execution engine), a neural network compiler 432, and a neural network runtime environment 433. The memory 426 includes computer-executable instructions for the tool flow including the modelling framework 431, the neural network compiler 432, and the neural network runtime environment 433. The tool flow can be used to generate neural network data 200 and model parameters 434 representing all or a portion of the neural network model, such as the neural network model discussed above regarding FIG. 2. It should be noted that while the tool flow is described as having three separate tools (431, 432, and 433), the tool flow can have fewer or more tools in various examples. For example, the functions of the different tools (431, 432, and 433) can be combined into a single modelling and execution environment.

The neural network data 200 can be stored in the memory 426. The neural network data 200 can be represented in one or more formats. For example, the neural network data 200 corresponding to a given neural network model can have a different format associated with each respective tool of the tool flow. Generally, the neural network data 200 can include a description of nodes, edges, groupings, weights, biases, activation functions, and/or tensor values. As a specific example, the neural network data 200 can include source code, executable code, metadata, configuration data, data structures and/or files for representing the neural network model.

The modelling framework 431 can be used to define and use a neural network model. As one example, the modelling framework 431 can include pre-defined APIs and/or programming primitives that can be used to specify one or more aspects of the neural network model. The pre-defined APIs can include both lower-level APIs (e.g., activation functions, cost or error functions, nodes, edges, and tensors) and higher-level APIs (e.g., layers, convolutional neural networks, recurrent neural networks, linear classifiers, and so forth). “Source code” can be used as an input to the modelling framework 431 to define a topology of the graph of a given neural network model. In particular, APIs of the modelling framework 431 can be instantiated and interconnected within the source code to specify a complex neural network model. A data scientist can create different neural network models by using different APIs, different numbers of APIs, and interconnecting the APIs in different ways.

In addition to the source code, the memory 426 can also store training data, such as the primary training data set 440 and the collected training data set 442. The training data includes a set of input data for applying to the neural network model 200 and a desired output from the neural network model for each respective dataset of the input data. The modelling framework 431 can be used to train the neural network model with the training data. An output of the training is stored with the model parameters 434 (e.g., weights and biases) that are associated with each node of the neural network model. After the neural network model is trained, the modelling framework 431 can be used to classify new data that is applied to the trained neural network model. Specifically, the trained neural network model uses the model parameters 434 obtained from training to perform classification and recognition tasks on data that has not been used to train the neural network model. The modelling framework 431 can use the CPU 420 and the special-purpose processors (e.g., the GPU 422 and/or the machine learning accelerator 424) to execute the machine learning model with increased performance as compared with using only the CPU 420. In some examples, the performance can potentially achieve real-time performance for some classification tasks.

The compiler 432 analyzes the source code and data (e.g., the examples used to train the model) provided for a neural network model and transforms the model into a format that can be executed on the CPU 420 and/or accelerated on the machine learning accelerator 424. Specifically, the compiler 432 transforms the source code into executable code, metadata, configuration data, and/or data structures for representing the neural network model and memory as neural network data 200. In some examples, the compiler 432 can divide the neural network model into portions (e.g., neural network 200) using the CPU 420 and/or the GPU 422) and other portions (e.g., a neural network subgraph) that can be executed on the machine learning accelerator 424. The compiler 432 can generate executable code (e.g., runtime modules) for executing graphs and/or subgraphs assigned to the CPU 420 and for communicating with the subgraphs assigned to the accelerator 424. The compiler 432 can generate configuration data for the accelerator 424 that is used to configure accelerator resources to evaluate the subgraphs assigned to the optional accelerator 424. The compiler 432 can create data structures for storing values generated by the machine learning model during execution and/or training and for communication between the CPU 420 and the accelerator 424. The compiler 432 can generate metadata that can be used to identify subgraphs, edge groupings, training data, and various other information about the neural network model during runtime. For example, the metadata can include information for interfacing between the different subgraphs of the neural network model.

The runtime environment 433 provides an executable environment or an interpreter that can be used to train the neural network model during a training mode and that can be used to evaluate the neural network model in training, inference, or classification modes. During the inference mode, input data can be applied to the neural network model inputs and the input data can be classified in accordance with the training of the neural network model. The input data can be archived data or real-time data.

The runtime environment 433 can include a deployment tool that, during a deployment mode, can be used to deploy or install all or a portion of the neural network to machine learning accelerator 424 and/or to edge devices in communication with the server computer system 400 (such as by using the client interface 444). The runtime environment 433 can further include a scheduler that manages the execution of the different runtime modules and the communication between the runtime modules, the machine language accelerator 424, and/or the edge devices. Thus, the runtime environment 433 can be used to control the flow of data between nodes modeled on the machine learning tool 410, the machine learning accelerator 424, and/or the edge devices.

Additionally, the runtime environment 433 can include or interface with retraining logic 450. The retraining logic 450 can be used to manage updating the model parameters 434. For example, the neural network model can be trained on the server computer system using the primary training data set 440 and then distributed and deployed to a group of edge devices. Each of the different edge devices can collect input data that may differ in some ways from the primary training data set 440. The accuracy of the neural network model can potentially be improved if selected input data collected by the edge devices is used to incrementally train the neural network model. The selected input data can be transmitted by the edge device and received by the client interface 444 to be stored in the collected training data set 442. The data in the collected training data set 442 can include a label that was added by the edge device or a label can be added (such as by a data scientist) after the data is uploaded to the server computer system 400. The data in the collected training data set 442 can include input data to the neural network model and/or gradient data from the neural network model.

The retraining logic 450 can use the data from the collected training data set 442 to incrementally train the neural network model to potentially improve the accuracy of the model for a more diverse set of data than the primary training data set 440. Specifically, the retraining logic 450 can perform the incremental training using the data of the collected training data set 442 to generate updated model parameters 434. Performing the incremental training can include using both a subset of the primary training data set 440 and the collected training data set 442 as inputs to the neural network model during a training mode of the neural network model. By using a mix of data from the primary training data set 440 and the collected training data set 442, the model may better classify input data that is similar to both the primary training data and the additional training data. The incremental training can be delayed until a threshold amount of additional training data is collected. For example, the computing resources used for training may be more efficiently used if incremental training begins after a threshold amount (e.g., 10% of an amount of the primary training data set 440) of additional training data is collected.

Some of the data of the collected training data set 442 may be more useful and/or trustworthy than other data. For example, adversarial users of the edge devices can potentially attempt to corrupt the model parameters 434 by sending forged data that could decrease the accuracy of the neural network model if the forged data is used for training. As another example, some edge devices may encounter unusual input data that is not representative of input data encountered by most edge devices, and so adjusting the neural network model to classify the non-representative input data may make the model less accurate.

Sample weighting logic 460 can be used to potentially reduce an impact of receiving the non-representative and/or forged data. For example, the sample weighting logic 460 can assign a trust-level to individual edge devices, and the training data from the individual edge devices can be weighted based on the trust-level of the respective edge device when the incremental training is performed. For example, edge devices can initially be assigned low levels of trust. If a given edge device provides training data that is determined to be useful in increasing an accuracy of the model, then the trust-level can be increased for the given edge device. In contrast, if a given edge device provides training data that is determined to be harmful to the accuracy of the model, then the trust-level can be decreased for the given edge device. This could occur when the given edge device sends many samples from different low-density areas of the state space of the model, for example. A weighting factor can be assigned to each of the trust-levels so that input data samples from more trusted edge devices are weighted more heavily than input data samples from less trusted edge devices when performing incremental training of the model.

The runtime environment 433 and/or retraining logic 450 can update the model parameters 434 as a result of performing the incremental training. After incremental training, the runtime environment 433 can transmit the updated model parameters 434 to the edge devices, such as by using the client interface 444. The updated model parameters 434 can be used by the edge devices to configure the model to potentially classify a wider range of input data than the initial set of training data more accurately than using the original, trained operational parameters.

FIG. 5 is a system diagram of an example client computing device 500 for performing incremental training of a machine learning tool 510, as can be implemented in certain examples of the disclosed technology. As shown in FIG. 5, the client computing device 500 can include a number of hardware resources including general-purpose processors 520 and optional special-purpose processors such as graphics processing units 522 and a machine learning accelerator 524. The processors are coupled to memory 526 and storage 528, which can include volatile or non-volatile memory devices. The processors 520 and 522 execute instructions stored in the memory or storage in order to provide a machine learning tool 510. The machine learning tool 510 includes software interfaces that allow the system to be programmed to implement various types machine learning models, such as neural networks. For example, software functions can be provided that allow applications to define neural networks including weights, biases, activation functions, node values, and interconnections between layers of a neural network. Additionally, software functions can be used to define state elements for recurrent neural networks. The machine learning tool 510 can further provide utilities to allow for training and retraining of a neural network implemented with the module. Values representing the machine learning tool are stored in memory or storage and are operated on by instructions executed by one of the processors. The values stored in memory or storage can be represented using normal-precision floating-point and/or quantized floating-point values.

The client computing device 500 can include one or more input devices 502 and one or more output devices 504. The input devices 502 can be used for collecting information about the environment and/or for communicating with a user of the client device. For example, the input devices 502 can include a microphone, a camera, a video camera, a keyboard, a computer mouse, and so forth. The output devices 504 can be used for communicating with the user of the client device. For example, the output devices 504 can include a speaker, a computer monitor, a printer, and so forth.

The machine learning tool 510 can include various components. As one example, the machine learning tool 510 can include a runtime environment 533, model parameters 534, and a quality analyzer module 535. The machine learning tool 510 can be a stripped-down or reduced functionality version of the machine learning tool 410 from FIG. 4. For example, the client computing device 500 may have reduced computing power, reduced memory or storage, or a reduced energy budget as compared to the server computer system 400. Accordingly, the modeling framework 531 and the compile 532 can be optional components on the client computing device 500.

The machine learning tool 510 (e.g., the runtime module 533) can receive raw and/or processed input data from the input device 502, and the machine learning tool 510 can be used to classify and/or extract features from the input data. The input data to the machine learning tool 510 can be spoken speech, images, time-series data such as temperatures from a temperature sensor, and so forth. The machine learning tool 510 can operate according to the model parameters 534. Initially, the model parameters 534 can be the same as the model parameters that were trained on a server computer in communication with the client computing device 500. The initial model parameters may be sufficiently accurate for a variety of input data, but the accuracy may be reduced when the client computing device 500 encounters new input data that differs in some aspect from the training data used to generate the initial model parameters.

The quality analyzer 535 can be used to analyze a quality of the results from the machine learning tool 510 to determine how similar the input data is to the training data for the machine learning tool 510. High-quality results can indicate that the machine learning tool 510 accurately predicted the classification of the input data, such as when the input data is similar to the training data. Low-quality results can indicate that the machine learning tool 510 did not accurately predict the classification of the input data such as when the input data differs in some way from the training data. The input data leading to the low-quality results can be helpful when used to supplement the initial training data during incremental training of the machine learning tool 510. By using the input data causing the low-quality results for incremental training, the machine learning tool 510 can be adjusted (e.g., the model parameters 534 can be updated) to better classify input data that is similar to the input data used for incremental training.

The quality analyzer 535 can use various techniques to determine the quality of the results from the machine learning tool 510 for a given set of input data. As one example, a misclassification by the machine learning tool 510 can indicate that the quality of the results is poor. Specifically, the classification from the machine learning tool 510 can be presented to a user of the client computing device 500 via a user interface presented on an output device 504 (such as a video screen or speaker). The user may indicate that the classification is incorrect by responding using the input device 502 (such as by correcting the classification using a keyboard or touchscreen). The quality analyzer 535 can mark the input data as data that was misclassified and the misclassified input data can be uploaded (with or without a correct label) using the upload logic 540 and server interface 542 to the server computer 110. The uploaded input data can be used to incrementally train the machine learning tool so that the model parameters 534 can be adjusted based on the new training data. For example, the server computer can perform the incremental training using the uploaded input data to generate updated model parameters that can be redistributed to the client computing device 500. The updated model parameters can be received by the server interface 542 and stored as the model parameters 534 so that the machine learning tool 510 is adapted to classify input data based on the new parameters.

As a specific example, the machine learning tool 510 can be an image classifier. A user of the client device 500 can take a picture of a rabbit, but the machine learning tool 510 may misclassify the picture as a cat. The user can recognize the misclassification and correctly label the image as a rabbit. The misclassification can be detected, and the image, along with the correct label (e.g., rabbit) can be uploaded to the server computer and used for incremental training. The new category of rabbit can be an existing classification recognized by the image classifier or a new classification. After incremental training, the updated model parameters can be downloaded to the model parameters 534. The updated model parameters 534 can improve the accuracy of the machine learning tool 510. For example, the machine learning tool 510 may now be able to classify rabbits, whereas the machine learning tool 510 did not originally even have a class for rabbits.

The quality analyzer 535 can also determine a quality of the results from the machine learning tool 510 in an unsupervised manner using mathematical and/or statistical properties of outputs of the machine learning tool 510. For example, the machine learning tool 510 can include a deep neural network and a perplexity of the outputs of the last layer can be used to determine the quality of the results. As described above, perplexity is a measure of a variability of a prediction model and/or a measure of prediction error. Additionally, the quality analyzer 535 can determine the quality of the results from the machine learning tool 510 using mathematical and/or statistical properties of intermediate outputs and/or final outputs of the machine learning tool 510. For example, the machine learning tool 510 can be a DNN having multiple layers of neurons. The quality of the results can be measured using statistical properties of the final layer and/or of a hidden layer, such as the layer that precedes the final layer. In other words, the quality of the results can be measured using a function that uses output values from a mixture of layers of the DNN model.

When low quality results (e.g., the input data was misclassified or the output(s) have high perplexity) are identified, the input data corresponding to the low-quality results can optionally be stored in the collected training data set 550. The collected training data set 550 can be stored in the memory 526 and/or storage 528. The upload logic 540 can manage uploading data from the collected training data set 550. For example, the upload logic 540 can periodically upload the data from the collected training data set 550 at a fixed time interval. As another example, the upload logic 540 can upload the data from the collected training data set 550 after a given amount of data has been collected. Using the upload logic 540 to manage uploads may reduce the overall communication bandwidth between the client computing device 500 and the server computer. Alternatively, the input data corresponding to the low-quality results can be uploaded when the low-quality results are identified.

While uploading the input data to the server computer can be useful for improving an accuracy of the machine learning tool 510, some users may prefer that the input data they collect remain private or confidential, such as when the data is business-sensitive, proprietary, or a of a personal nature. The privacy settings 560 can be used to control how the input data is shared. For example, the privacy settings 560 can be set to one or more private modes or a public mode. When the privacy settings 560 are set to public, the input data corresponding to the low-quality results can be uploaded to the server computer as described above, so that the incremental training can occur on the server computer using the input data.

A first private mode, referred to as private-shared herein, can be used to keep the input data confidential, but also provide training data to the server computer so that the server computer can perform incremental training for the machine learning tool 510. When the privacy settings 560 are set to private-shared, the input data can remain confidential and training data can also be sent to the server computer. For example, when the quality analyzer 535 detects that input data corresponds to low-quality results, the outputs can be back-propagated through the machine learning model to generate one or more gradient values of the model. Specifically, the retraining logic 570 can initiate the back-propagation of the low-quality output results through the machine learning model to generate the gradient values. The gradient values can be stored in the collected training data set 550 and/or uploaded to the server computer using the upload logic 540 and server interface 542. The server computer can complete the incremental training by aggregating the gradients from various client devices and updating the operational parameters of the machine learning model. Thus, the incremental training can be partially performed at the client computing device 500 and partially performed at the server computer.

A second private mode, referred to as private-local herein, can be used to keep the input data confidential and to keep changes to the model parameters local. When the privacy settings 560 are set to private-local, the incremental training for the machine learning tool 510 can be performed only at the client device 500 and the updated model parameters are stored in the model parameters 534 and not uploaded to the server computer. Specifically, the incremental training can be initiated by the retraining logic 570 to generate the updated model parameters to be stored in the model parameters 534. The private-local mode can enable the client computing device 500 to be customized based on the qualities of the input data that it encounters, while the model parameters stored at the server computer are not affected by the particular qualities of the input data encountered by the client device 500.

Additional modes are possible, such as modes that enable customization for groups of users. For example, different model parameters can be maintained for different respective groups of users. As a specific example, the users of a speech recognition tool can be divided into different groups based on a region of a country and/or based on their native language. Users that are native English speakers from the southern United States can be in one group, non-native English speakers from China can be in another group, and so forth.

### Example Methods

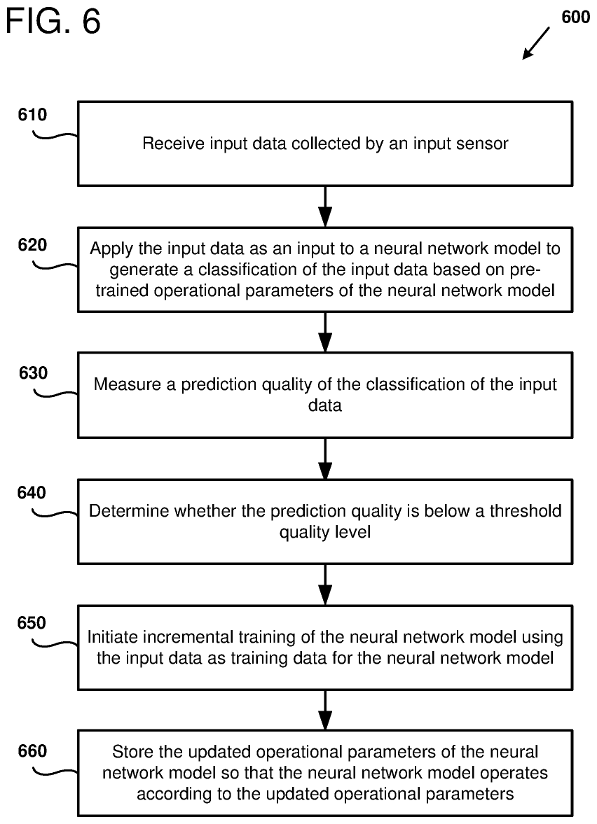

FIG. 6 illustrates a method 600 of updating operational parameters of a neural network model using a client computing device. As one example, the method 600 can be performed by a client computing device, such as the client device 120 of FIG. 1 or the client computing device 500 of FIG. 5.

At process block 610, input data collected by an input sensor can be received. For example, the input data can be an image from a camera, a series of images from a video camera, spoken speech or other sounds captured by a microphone, temperatures from a temperature sensor, pressures captured from a pressure sensor, rainfall amounts captured from a rain sensor, and so forth.

At process block 620, the input data collected by the input sensor can be applied as an input to a neural network model to generate a classification of the input data based on pre-trained operational parameters. The classification is based on the model parameters of the neural network model at the time of processing the input data.

At process block 630, a prediction quality of the classification of the input data can be measured. The prediction quality can be based on whether the input data was misclassified and/or based on a statistical or mathematical function of a final or intermediate output of the neural network model. For example, the prediction quality can be measured based on a perplexity function of one or more layers of the neural network model. The perplexity function can be based on properties of only output values of the output layer (e.g., entropy) and/or based on a comparison between the output values of the output layer and a one-hot vector (e.g., cross-entropy). The measurement of prediction quality can measure whether intermediate outputs of the neural network model are within expected ranges of the intermediate outputs. For example, the measurement of prediction quality can determine whether an output of a hidden layer falls within a known cluster (e.g., a subclass) of the hidden layer.

At process block 640, it can be determined whether the prediction quality is below a threshold quality level. The prediction quality can be below the threshold quality level when the input data was misclassified or the perplexity value is greater than a predefined value. For example, a higher perplexity value can indicate that the input data is different and some way from the data that was used to train the neural network model. Thus, using the misclassified data or the data with high perplexity can be helpful to supplement the training set and to make the neural network model more accurate.

At process block 650, incremental training of the neural network model can be initiated using the input data as training data for the neural network model. For example, the incremental training can be initiated in response to determining the prediction quality is below the threshold quality level. The incremental training can be performed at a client device, a server computer, or a combination thereof. For example, the location(s) for performing the incremental training can be based on one or more factors, such as a privacy setting of the client device, capabilities supported by a runtime module of the client device, and whether updates are intended for a local device or a broader user base.

When the privacy setting is determined to be private, initiating the incremental training of the neural network model can include calculating a gradient function of the neural network model at the client device and transmitting an output of the gradient function to the server computer. The server computer can complete the incremental training by aggregating the gradients from various client devices and updating the operational parameters of the neural network model. Thus, the incremental training can be partially performed at the client device and partially performed at the server. When the privacy setting is determined to be public, initiating the incremental training of the neural network model can include transmitting the input data to the server computer which can complete the incremental training using the input data. The client device may have reduced computing power or a reduced energy budget and so the incremental training can be delegated to the server computer (e.g., the input data can be transmitted to the server computer) to reduce a code footprint and/or reduce energy consumption of the client device. An application executing on the client device can keep updates to the operational parameters local to the client device, such as when the updates are intended for personalizing the neural network model to the local device. Alternatively, the application executing on the client device can update operational parameters for the server computer and all client devices communicating with the server, such as by performing the incremental training of the neural network model and distributing the updated operational parameters to local server computer memory and/or storage and to the individual client devices. An output of the incremental training is updated operational parameters of the neural network model.

At process block 660, the updated operational parameters of the neural network model can be stored so that the neural network model operates according to the updated operational parameters. The updated operational parameters can be stored on a computer-readable medium such as memory or a storage device of the client device.

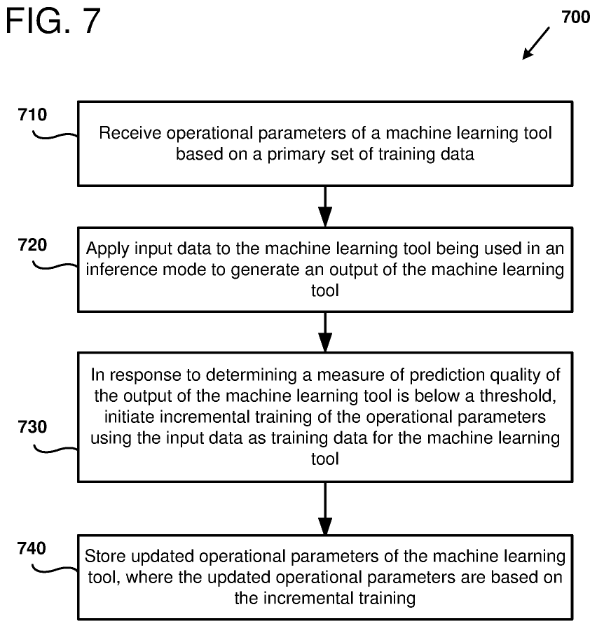

FIG. 7 illustrates a method 700 of updating operational parameters of a neural network model using a client computing device, as can be implemented in certain examples of the disclosed technology. As one example, the method 700 can be performed by a client computing device, such as the client device 120 of FIG. 1 or the client computing device 500 of FIG. 5.

At process block 710, operational parameters of a machine learning tool can be received. The operational parameters can be based on a primary set of training data. For example, the machine learning tool can be a deep neural network having multiple hidden layers and the trained operational parameters can be weights and biases of the deep neural network. The primary set of training data can include data that is stored on a server computer.

At process block 720, input data can be applied to the machine learning tool. The machine learning tool can be used in an inference mode to generate an output (e.g., feature extraction or a classification of the input data) of the machine learning tool. For example, the input data can be an image from a camera and the output can be a class or type of the image; the input data can be spoken speech captured by a microphone and the output can be a phoneme or a word, and so forth. The output of the machine learning tool is based on the input data and the operational parameters received at 710.

At process block 730, in response to determining a measure of prediction quality of the output of the machine learning tool is below a threshold, incremental training of the operational parameters can be initiated using the input data as training data for the machine learning tool. The measure of prediction quality can be based on whether the input data was misclassified and/or based on a statistical or mathematical function of a final or intermediate output of the machine learning tool. For example, the machine learning tool can be a DNN model and the prediction quality can be measured based on a perplexity function of one or more layers of the DNN model. The perplexity function can be based on properties of only output values of the output layer (e.g., entropy) and/or based on a comparison between the output values of the output layer and a one-hot vector (e.g., cross-entropy). The measurement of prediction quality can measure whether intermediate outputs of the DNN model are within expected ranges of the intermediate outputs. For example, the measurement of prediction quality can determine whether an output of a hidden layer falls within a known cluster (e.g., a subclass) of the hidden layer. The prediction quality can be below the threshold quality level when the input data was misclassified or the perplexity value is greater than a predefined value. For example, a higher perplexity value can indicate that the input data is different and some way from the data that was used to train the machine learning tool. Thus, using the misclassified data or the data with high perplexity can be helpful to supplement the training set and to make the machine learning tool more accurate.

Incremental training of the machine learning tool can be initiated using the input data as training data for the machine learning tool. The incremental training can be performed at a client device, a server computer, or a combination thereof. For example, the location(s) for performing the incremental training can be based on one or more factors, such as a privacy setting of the client device, capabilities supported by a runtime module of the client device, and whether updates are intended for only a local device or a broader user base.

When the privacy setting is determined to be private, initiating the incremental training of the machine learning tool can include calculating a gradient or error function of the machine learning tool at the client device and transmitting an output of the gradient function to the server computer. The server computer can complete the incremental training by aggregating the gradients from various client devices and updating the operational parameters of the machine learning tool. Thus, the incremental training can be partially performed at the client device and partially performed at the server. When the privacy setting is determined to be public, initiating the incremental training of the machine learning tool can include transmitting the input data to the server computer which can complete the incremental training using the input data. The client device may have reduced computing power or a reduced energy budget and so the incremental training can be delegated to the server computer (e.g., the input data can be transmitted to the server computer) to reduce a code footprint and/or reduce energy consumption of the client device. An application executing on the client device can keep updates to the operational parameters local to the client device, such as when the updates are intended for personalizing the machine learning tool to the local device. Alternatively, the application executing on the client device can update operational parameters for the server computer and all client devices communicating with the server, such as by performing the incremental training of the machine learning tool and distributing the updated operational parameters to local server computer memory and/or storage and to the individual client devices. An output of the incremental training is updated operational parameters of the machine learning tool.

At process block 740, the updated operational parameters of the machine learning tool from the incremental training can be stored. Storing the updated operational parameters of the neural network model can cause the machine learning tool to operate according to the updated operational parameters. The updated operational parameters can be stored on a computer-readable medium such as memory or a storage device of the client device.

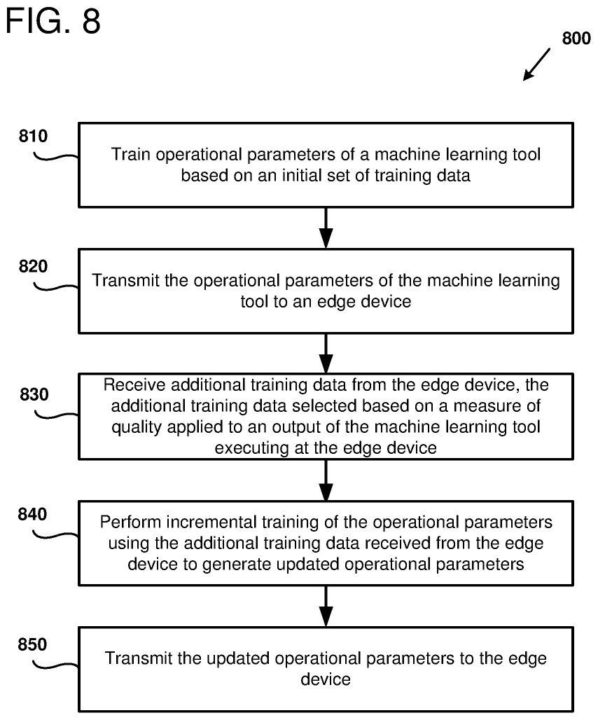

FIG. 8 illustrates a method 800 of performing incremental training of a machine learning tool using a server computer, as can be implemented in certain examples of the disclosed technology. As one example, the method 800 can be performed by a server computer system, such as the server computer 110 of FIG. 1 or the server computer system 400 of FIG. 4.

At process block 810, operational parameters of a machine learning tool can be trained. The training can be based on an initial set of training data. The machine learning tool can be a deep neural network having a plurality of hidden layers, and the operational parameters can include weights of edges of the deep neural network. The operational parameters can also include biases of nodes of the deep neural network.

At process block 820, the operational parameters of the machine learning tool can be transmitted to an edge device. The operational parameters can be used by the edge device to configure the machine learning tool to classify input data that is similar in some ways to the initial set of training data. The machine learning tool may perform less accurately as the input data at the edge device differs more substantially from the initial set of training data. By measuring the quality of the output from the machine learning tool, new training data can be identified. For example, input data that is classified with low confidence (such as when a user provides input that identifies the data as misclassified, or when a perplexity measure is greater than a threshold) may be useful for supplementing the initial set of training data. The input data (or a gradient of the input data) that is classified with low confidence can be transmitted to the server computer.

At process block 830, additional training data can be received from the edge device. The additional training data can be selected based on a measure of quality applied to an output of the machine learning tool executing at the edge device. The additional training data can be input data of the machine learning tool that is collected at the edge device. Additionally or alternatively, the additional training data can be a gradient of the machine learning tool calculated by back-propagating an output of the machine learning tool, where the output was generated using input data collected at the edge device.

At process block 840, incremental training of the operational parameters can be performed using the additional training data received from the edge device to generate updated operational parameters. The server computer can assign a level of trust to the individual edge devices to potentially protect from an edge device submitting erroneous or adversarial training data. The additional training data can be weighted based on the trust-level of the edge device when the incremental training is performed. In this manner, more trusted edge devices can affect the training more than less trusted edge devices. Performing the incremental training can include using both a subset of the initial set of training data and the additional training data as inputs to the machine learning tool during a training mode of the machine learning tool. By using some of the initial training data and the additional training data, the model may better classify input data that is similar to both the initial training data and the additional training data. The incremental training can be delayed until a threshold amount of additional training data is received. For example, the computing resources used for training may be more efficiently used if incremental training begins after a threshold amount (e.g., 10% of an amount of the initial training data) of additional training data is received.

At process block 850, the updated operational parameters can be transmitted to the edge device. The updated operational parameters can be used by the edge device to configure the machine learning tool to potentially classify a wider range of input data than the initial set of training data more accurately than using the original operational parameters.

### Additional Examples of the Disclosed Technology

Additional examples of the disclosed subject matter are discussed herein in accordance with the examples discussed above.

In one example, a computing system can be used to update operational parameters of a neural network model. The computing system includes an input sensor, a computer-readable medium storing trained operational parameters of the neural network model, and a processor in communication with the input sensor and the computer-readable medium. The processor is configured to receive input data collected by the input sensor. The input data is applied as an input to the neural network model to generate a classification of the input data based on the trained operational parameters. A prediction quality of the classification of the input data is measured. It can be determined whether the prediction quality is below a threshold quality level. In response to determining the prediction quality is below the threshold quality level, incremental training of the neural network model is initiated using the input data as training data for the neural network model. An output of the incremental training is updated operational parameters of the neural network model. The updated operational parameters of the neural network model are stored on the computer-readable medium so that the neural network model operates according to the updated operational parameters.

Initiating the incremental training of the neural network model can include determining a privacy setting of the computing system. When the privacy setting is determined to be private, initiating the incremental training of the neural network model can include calculating a gradient function of the neural network model. Initiating the incremental training of the neural network model can include transmitting an output of gradient function to a server computer so that the server computer performs the incremental training of the neural network model based on the output of the gradient function. When the privacy setting is determined to be public, initiating the incremental training of the neural network model can include transmitting the received input data to a server computer.

Determining the prediction quality is below the threshold quality level can include determining the input data was misclassified. The neurons of a last layer of the neural network model can use a soft-max activation function. Determining the prediction quality is below the threshold quality level can include determining a perplexity function based on outputs of the last layer of the neural network model and a one-hot vector. Determining the prediction quality is below the threshold quality level can include determining a perplexity function based on outputs of one or more layers of the neural network model. Determining the prediction quality is below the threshold quality level can include determining a perplexity function based on outputs of a mixture of layers of the neural network model. For example, determining the prediction quality is below the threshold quality level can include determining a perplexity function based on outputs of a last layer and an earlier hidden layer of the neural network model.

In one example, a method can be used to update operational parameters of a machine learning tool. The method includes receiving operational parameters of a machine learning tool based on a primary set of training data. For example, the machine learning tool can be a deep neural network comprising a plurality of hidden layers. Input data is applied to the machine learning tool, where the machine learning tool is being used in an inference mode to generate an output of the machine learning tool. In response to determining a measure of prediction quality of the output of the machine learning tool is below a threshold, incremental training of the operational parameters is initiated. For example, the measure of prediction quality can be a function of intermediate and final outputs of the machine learning tool. When the machine learning tool is a DNN model, the measure of prediction quality can be an output of a hidden layer from a plurality of hidden layers of the DNN model. Initiating the incremental training of the machine learning tool can include calculating a gradient function of the machine learning tool. The incremental training uses the input data as training data for the machine learning tool. Updated operational parameters are generated based on the incremental training. The updated operational parameters of the machine learning tool are stored. For example, the output of the incremental training can be stored only on a local device performing the incremental training and not be transmitted to a server computer. Additionally, the generated output of the machine learning tool can be stored only on a local device performing the incremental training and not be transmitted to a server computer.

In one example, a method can be used to perform incremental training of operational parameters of a machine learning tool. For example, the machine learning tool can be a deep neural network including a plurality of hidden layers, and the operational parameters can include weights of edges of the deep neural network. The method includes training the operational parameters of the machine learning tool based on an initial set of training data. The operational parameters of the machine learning tool are transmitted to an edge device. Additional training data is received from the edge device. The additional training data is selected based on a measure of quality applied to an output of the machine learning tool executing at the edge device. Incremental training of the operational parameters is performed using the additional training data received from the edge device to generate updated operational parameters. The updated operational parameters are transmitted to the edge device.

The additional training data can be input data of the machine learning tool, the input data collected at the edge device. The additional training data can be a gradient of the machine learning tool calculated by back-propagating an output of the machine learning tool, where the output was generated using input data collected at the edge device. A trust-level of the edge device can be evaluated, and the additional training data can be weighted based on the trust-level of the edge device when the incremental training is performed. Performing incremental training can include using both a subset of the initial set of training data and the additional training data as inputs to the machine learning tool during a training mode of the machine learning tool. The incremental training can be delayed until a threshold amount of additional training data is received.

### Example Computing Environment

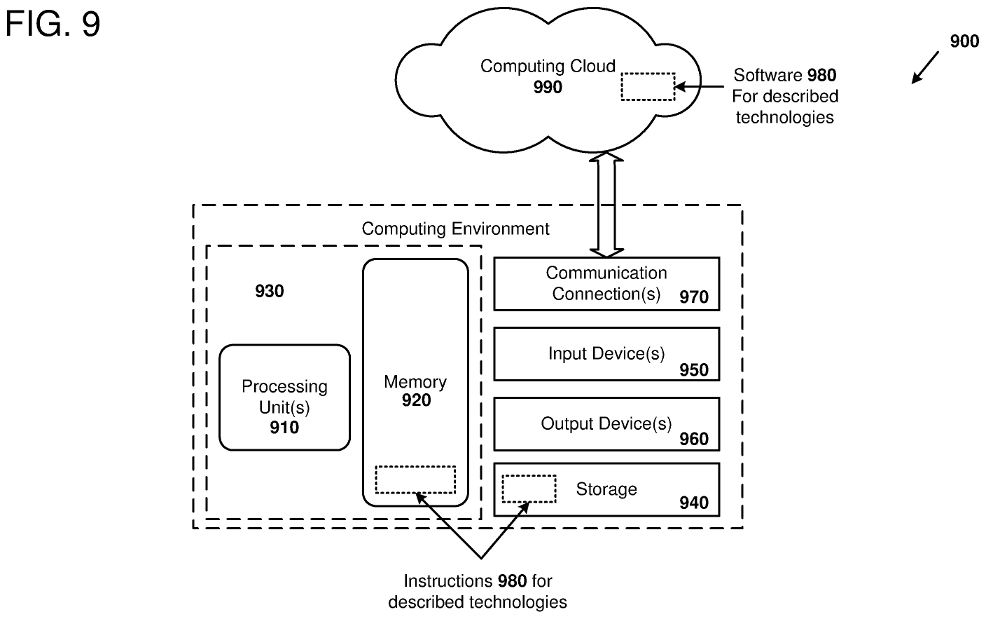

FIG. 9 illustrates a generalized example of a suitable computing environment 900 in which described examples, techniques, and technologies, including supporting incremental training of machine learning tools, can be implemented.

The computing environment 900 is not intended to suggest any limitation as to scope of use or functionality of the technology, as the technology may be implemented in diverse general-purpose or special-purpose computing environments. For example, the disclosed technology may be implemented with other computer system configurations, including hand held devices, multi-processor systems, programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 9, the computing environment 900 includes at least one processing unit 910 and memory 920. In FIG. 9, this most basic configuration 930 is included within a dashed line. The processing unit 910 executes computer-executable instructions and may be a real or a virtual processor. In a multi-processing system, multiple processing units execute computer-executable instructions to increase processing power and as such, multiple processors can be running simultaneously. The memory 920 may be volatile memory (e.g., registers, cache, RAM), non-volatile memory (e.g., ROM, EEPROM, flash memory, etc.), or some combination of the two. The memory 920 stores software 980, images, and video that can, for example, implement the technologies described herein. A computing environment may have additional features. For example, the computing environment 900 includes storage 940, one or more input devices 950, one or more output devices 960, and one or more communication connections 970. An interconnection mechanism (not shown) such as a bus, a controller, or a network, interconnects the components of the computing environment 900. Typically, operating system software (not shown) provides an operating environment for other software executing in the computing environment 900, and coordinates activities of the components of the computing environment 900.

The storage 940 may be removable or non-removable, and includes magnetic disks, magnetic tapes or cassettes, CD-ROMs, CD-RWs, DVDs, or any other medium which can be used to store information and that can be accessed within the computing environment 900. The storage 940 stores instructions for the software 980, which can be used to implement technologies described herein.

The input device(s) 950 may be a touch input device, such as a keyboard, keypad, mouse, touch screen display, pen, or trackball, a voice input device, a scanning device, or another device, that provides input to the computing environment 900. For audio, the input device(s) 950 may be a sound card or similar device that accepts audio input in analog or digital form, or a CD-ROM reader that provides audio samples to the computing environment 900. The output device(s) 960 may be a display, printer, speaker, CD-writer, or another device that provides output from the computing environment 900.

The communication connection(s) 970 enable communication over a communication medium (e.g., a connecting network) to another computing entity. The communication medium conveys information such as computer-executable instructions, compressed graphics information, video, or other data in a modulated data signal. The communication connection(s) 970 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed computing systems. In a virtual host environment, the communication(s) connections can be a virtualized network connection provided by the virtual host.

Some examples of the disclosed methods can be performed using computer-executable instructions implementing all or a portion of the disclosed technology in a computing cloud 990. For example, the disclosed methods can be executed on processing units 910 located in the computing environment 930, or the disclosed methods can be executed on servers located in the computing cloud 990.

Computer-readable media are any available media that can be accessed within a computing environment 900. By way of example, and not limitation, with the computing environment 900, computer-readable media include memory 920 and/or storage 940. As should be readily understood, the term computer-readable storage media includes the media for data storage such as memory 920 and storage 940, and not transmission media such as modulated data signals.

In view of the many possible examples to which the principles of the disclosed subject matter may be applied, it should be recognized that the illustrated examples are only preferred examples and should not be taken as limiting the scope of the claims to those preferred examples. Rather, the scope of the claimed subject matter is defined by the following claims. We therefore claim as our invention all that comes within the scope of these claims.

Wat is claimed is:

1. A computing system comprising:
a processor in communication with an input sensor and a computer-readable medium storing trained operational parameters of a neural network model, the processor configured to:
apply input data collected by the input sensor to the neural network model to generate a classification of the input data based on the trained operational parameters;
measure a prediction quality of the classification of the input data;
determine whether the prediction quality is below a threshold quality level;
in response to determining the prediction quality is below the threshold quality level, initiate incremental training of the neural network model using the input data as training data for the neural network model, wherein an output of the incremental training is updated operational parameters of the neural network model; and
store the updated operational parameters of the neural network model on the computer-readable medium so that the neural network model operates according to the updated operational parameters.

2. The computing system of claim 1, wherein initiating the incremental training of the neural network model comprises determining a privacy setting of the computing system.

3. The computing system of claim 2, wherein the privacy setting is determined to be private, and the initiated incremental training of the neural network model comprises calculating a gradient function of the neural network model.

4. The computing system of claim 3, wherein the initiated incremental training of the neural network model comprises transmitting an output of gradient function to a server computer so that the server computer performs the incremental training of the neural network model based on the output of the gradient function.

5. The computing system of claim 2, wherein the privacy setting is determined to be public, and the initiated incremental training of the neural network model comprises transmitting the received input data to a server computer.

6. The computing system of claim 1, wherein the processor is further configured to determine the prediction quality is below the threshold quality level by determining the input data was misclassified.

7. The computing system of claim 1, wherein neurons of a last layer of the neural network model use a soft-max activation function, and the processor is further configured to determine the prediction quality is below the threshold quality level by determining a perplexity function based on outputs of the last layer of the neural network model and a one-hot vector.

8. The computing system of claim 1, wherein the processor is further configured to determine the prediction quality is below the threshold quality level by determining a perplexity function based on outputs of a mixture of layers of the neural network model.

9. A method comprising:
producing operational parameters of a machine learning tool based on a primary set of training data;
applying input data to the machine learning tool being used in an inference mode to generate an output of the machine learning tool;
in response to determining a measure of prediction quality of the output of the machine learning tool is below a threshold, initiating incremental training of the operational parameters using the input data as training data for the machine learning tool; and
storing updated operational parameters of the machine learning tool, the updated operational parameters being based on the incremental training.

10. The method of claim 9, wherein the machine learning tool is a deep neural network comprising a plurality of hidden layers.

11. The method of claim 10, wherein the measure of prediction quality is a function of an output of a hidden layer from the plurality of hidden layers of the deep neural network.

12. The method of claim 9, wherein initiating the incremental training of the machine learning tool comprises calculating a gradient function of the machine learning tool.

13. The method of claim 9, wherein the generated output of the machine learning tool is stored only on a local device performing the incremental training and is not transmitted to a server computer.

14. A method of training operational parameters of a machine learning tool, the method comprising:
training the operational parameters of the machine learning tool based on an initial set of training data;
transmitting the operational parameters of the machine learning tool to an edge device via an interconnection network;
receiving additional training data from the edge device, the additional training data selected based on a measure of quality applied to an output of the machine learning tool executing at the edge device;
performing incremental training of the operational parameters using the additional training data received from the edge device to generate updated operational parameters; and
transmitting the updated operational parameters to the edge device.

15. The method of claim 14, wherein the machine learning tool uses a deep neural network comprising a plurality of hidden layers, and the operational parameters include weights of edges of the deep neural network.

16. The method of claim 14, wherein the additional training data is input data of the machine learning tool, the input data collected at the edge device.

17. The method of claim 14, wherein the additional training data is a gradient of the machine learning tool calculated by back-propagating an output of the machine learning tool, the output generated using input data collected at the edge device.

18. The method of claim 14, further comprising evaluating a trust-level of the edge device, and wherein the additional training data is weighted based on the trust-level of the edge device when the incremental training is performed.

19. The method of claim 14, wherein performing incremental training comprises using both a subset of the initial set of training data and the additional training data as inputs to the machine learning tool during a training mode of the machine learning tool.

20. The method of claim 14, wherein the incremental training is delayed until a threshold amount of additional training data is received.
